(19) United States
(12) Patent Application Publication
(10) Pub. No.: US 2010/0117017 A1
(43) Pub. Date: May 13, 2010

(54) STEPPED FLOW CONTROL VALVE

(76) Inventor: IVAN J. FREYRE, RANCHO CUCAMONGA, CA (US)

Correspondence Address: BUHLER ASSOCIATES;BUHLER, KIRK A., 1101 CALIFORNIA AVE., SUITE 208, CORONA, CA, 92881, US

(21) Appl. No.: 12/616,525

(22) Filed: Nov. 11, 2009

Related U.S. Application Data
(60) Provisional application No. 61/113,562, filed on Nov. 11, 2008.

(51) Int. Cl. F16K 51/00

(52) U.S. Cl. 251/285

(57) ABSTRACT

A replacement for a flow shut off valve is disclosed. A typical flow shut-off valve is normally located between the water supply and the user operated valves that supply water to a faucet. The improvements in this application provides a replacement flow shut off valve where the flow control valve has finite flow steps to reduce water that wasted when the user's valve is fully opened. The valve has features for a lock that eliminates an unauthorized person from fully opening the valve without unlocking the valve. In addition to the valve providing water savings from the regulation the lower flow through the faucet reduces splatter from the faucet from high flow or pressure water bounces off the bottom of a basin.

### CROSS REFERENCE TO RELATED APPLICATION

Not Applicable

This application claims the benefit of Provisional 61/113,562 filed Nov. 11, 2008 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to improvements in water conservation. More particularly, the present invention is replacement for a flow shut off valve that is normally located between the water supply and the user operated valves that supply water to a faucet. The improvement is to provide a replacement flow shut off valve with a flow control valve with finite flow steps to reduce water that wasted when the user's valve is fully opened.

2. Description of Related Art Including Information Disclosed Under 37 CFR 1.97 and 1.98

Typical shutoff-off valves are intended to be either completely opened or closed. While they can offer some form of flow regulation there is no mechanism to prevent tampering of the shut-off valve from regulated flow. These valves are also intended for being either completely opened or completely closed. Setting the valve to a position other than fully open or closed can cause a build-up of deposits such as calcium to form and inhibit adjustment of the valve in the future. Some exemplary examples of shut-off valves and methods to control or reduce flow through a faucet are discussed herein below.

U.S. Pat. Nos. 7,124,999 and 7,172,173 issued to Hung-Lin Lai U.S. Pat. No. 6,302,339 issued Oct. 16, 2001 to Hsiao-Tsung Chou discloses a Continuously Adjustable Water Flow Control Apparatus. Both of these patents disclose a valve with a flow limiting pin that allows for limited adjustment of flow through the valve. If the flow limiting pin is removed the person will still have the ability to open the valve and allow full flow of the water. While this valve allows for some water saving through a faucet. It does not provide finite steps of water conservation nor does it allow for a locking mechanism to prevent re-adjustment of the flow by an unauthorized person.

U.S. Pat. No. 6,695,281 issued Feb. 24, 2004 to Edward Chuck Williams Jr. discloses a Water Flow Control Device Incorporating Water Limiting Valve. Continuously Adjustable Water Flow Control Apparatus. This patent mostly includes a motion sensor that stops the flow when a person is not sensed near the faucet. While there is some water savings with this device, the majority of the savings is from water that would be wasted when a person leaves the faucet open and unattended.

U.S. Pat. No. 6,681,418 issued Jan. 27, 2004 to Gary D. Bierend et al., discloses a Water Flow Control Device. The water flow control device operated mostly as a pressure regulator because a spring located within the valve will allow for nearly an open flow of fluid through the valve when the difference in pressure on both sides of the valve is significantly different. While this valve provides some reduction in flow through the valve it does not allow for finite steps of regulation or provide a lock to prevent tampering.

U.S. Pat. No. 6,302,339 issued Oct. 16, 2001 to Hsiao-Tsung Chou discloses a Continuously Adjustable Water Flow Control Apparatus. The adjustment is made by turning the spray head of the faucet. When the spray head is turned the flow is reduced. While this reduces the flow rate the pressure at the spray head is also increased whereby the creating a stream that has higher velocity and splatters. There is nothing to prevent a person from adjusting the nozzle to eliminate any water savings.

What is needed is a flow shut-off valve that is a simple replacement to standard shut-off valves and further includes a locking mechanism to prevent unauthorized tampering or adjustment. The proposed disclosure provides this disclosure with a valve that can be retrofit or installed new on a faucet to provide at least one level of water savings.

### BRIEF SUMMARY OF THE INVENTION

It is an object of the lockable flow control valve for the valve to regulate the amount or rate of fluid flowing through the valve. The regulation has a closed setting and one or a plurality of finite flow settings. Each setting provides definite steps of flow limitation. Each finite step provides flow rates that are less than a full open setting.

It is an object of the lockable flow control valve to provide a lock that prevents tampering and adjustment without removal of the lock. The lock can be a variety of type but in general the lock is a plurality of holes that will accept a standard padlock or a simple loop of a tie-wrap or screw and nut.

It is another object lockable flow control valve to limit the flow rate to reduce splatter if a watering valve is fully opened. When the flow rate to the faucet is not limited a person washing their hands may inadvertently fully opened and the flow stream can bounce off of the bottom of the basin and splatter back onto the person.

It is still another object of the lockable flow control valve to replace an existing valve. While the flow valve has couplings that will directly replace standard valve it is equally suited for installation in new construction.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a perspective view of a typical faucet.

FIG. 2 shows an isometric view of a prior art 90 degree shut-off valve.

FIG. 3 shows an isometric view of a prior art straight water shut-off valve.

FIG. 4 shows a front view of the lockable flow regulation valve.

FIG. 5 shows another embodiment of the locking plate from FIG. 4.

FIG. 6 shows a view of the three different orifices that provided different flow rates.

FIG. 7 shows a view of an alternative orifice plate showing three different orifices that provided different flow rates.

FIG. 8 shows a perspective view of a cylindrical gate with different sized orifices.

FIG. 9 shows a perspective sectional view of the preferred embodiment of the orifice tube.

FIG. 10 shows a cross sectional view of the finite flow regulation valve.

FIG. 11 shows a perspective sectional view of the finite flow regulation valve.

FIG. 12 shows a top view of a flow valve with variable operation force.

FIG. 13 shows a side view of the flow valve with variable operation force as shown in FIG. 12.

### DETAILED DESCRIPTION OF THE INVENTION

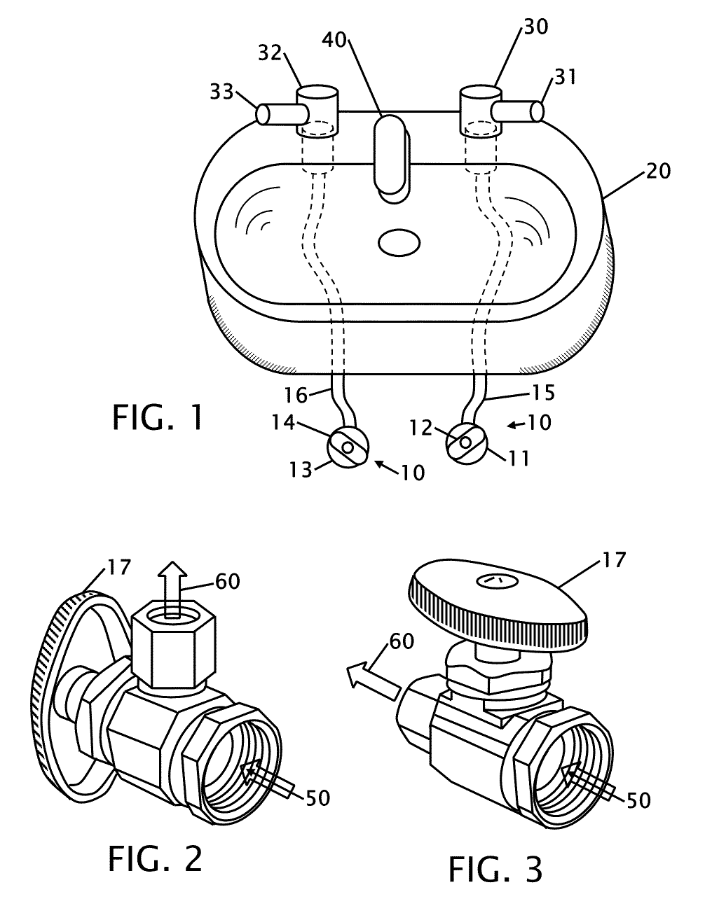

FIG. 1 shows a perspective view of a typical faucet. In a typical sink shut-off valves are connected from the supply lines through shut-off valves 10. Flow from the shut-off valves 10 flow through connecting pipes 15 and 16 to the user operated valves 30 and 32 that a user operates to allow flow to the faucet. There are usually two shut-off valves 10 where one shut-off vales where one valve is connected to the cold water supply 11 and the second valve is connected to the hot water supply 13. Each valve 10 has a manually operated control knob 12 or 14 that allows for shutting off the supply of water when repair, servicing or replacement of the valves 30, 32 or the entire faucet or sink 20 is being replaced. Valves 30 and 32 are opened by turning handles 31, 33 or the like to allow flow from the supply through valves 10, 30 and 32 through faucet 40.

Prior art valves 10 are generally designed for use either in a fully opened or a fully closed condition. Setting these prior art vales to a setting other that fully open or closed can result in damage or corrosion in the valve that makes the valve inoperable. There is no provision on these valves 10 to lock regulate of the flow to reduce water waste.

FIGS. 2 and 3 shows isometric views of a prior art 90-degree and straight shut-off valves These two valves represent to most common configuration for shut-off valves. Both of these valves have an inlet 50 where water flows from the supply. Knob 15 is turned to open and shut-off the flow from the inlet 50 to the outlet 60.

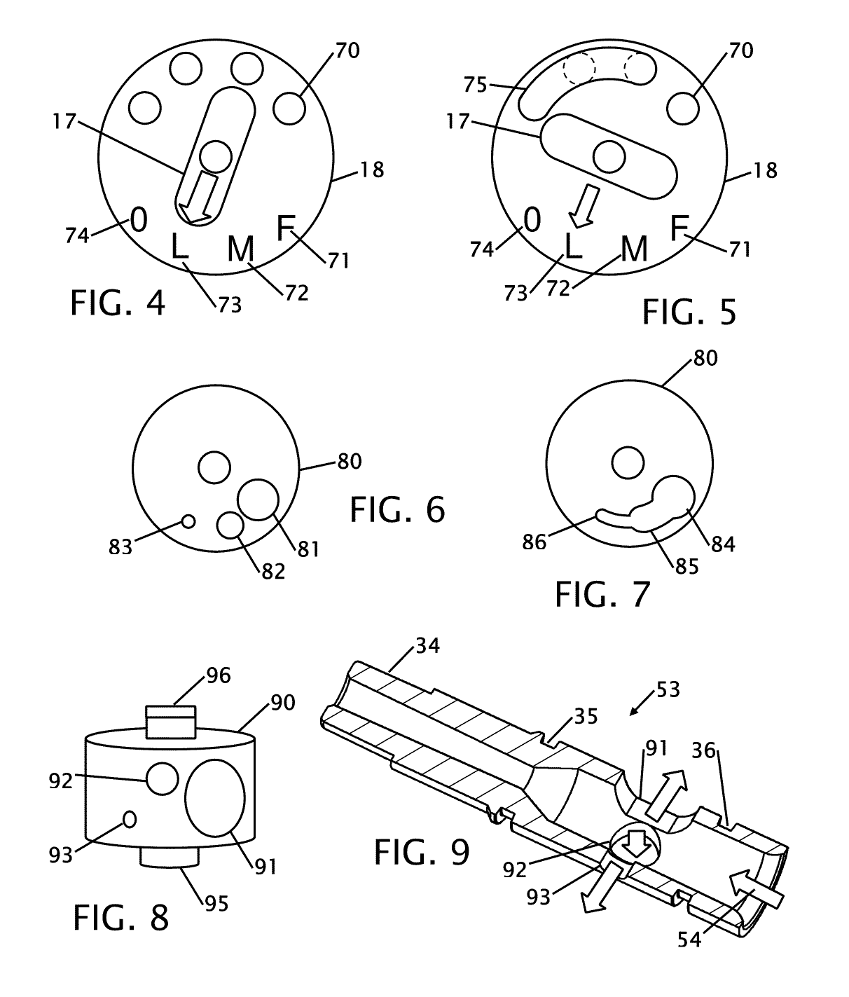

The manually operated valves 30 and 32 shown in FIG. 1 allow turning of approximately 90 degrees to fully open and close the valve. Because of the minimal amount of rotation that is necessary to open close these manual valves few people open the valves 30 and 32 to a setting of less than full flow. Regulation of the flow by turning down the shut-off valves is easily defeated by an unauthorized person. FIG. 4 shows a replacement shut-off valve that can replace existing shut-off valves to limit flow through the faucet and further provides a locking feature that prevents unauthorized tampering.

FIG. 4 shows a front view of the lockable flow regulation valve. The handle 16 has a knob 15 that is adjustable to identify the limited flow and lock the valve at the desired flow regulation. The indicator knob 17 has an arrow that points to a full flow setting 71, medium setting 72, a low flow setting 73 and an offsetting 74. A series of holes 70 on the handle 18 are used for installation of a lock, tie-wrap, screw and nut, zip tie or other similar mechanism that is placed through the hole to prevent unauthorized adjustment of the flow setting. In one contemplated embodiment, shown in FIG. 5, the locking holes 70 are slotted 75 to allow the valve to be completely shut off in the event of an emergency and only opened to the amount that the valve was previously set. This allows for regulation without compromising the ability to close the valve.

FIG. 6 shows a view of the three different orifices that provided different flow rates. This orifice plate 80 has three sets of different sized orifices that are specifically selected to provide a desired flow rate from a faucet. It should be apparent that orifice 83 provides the most limited flow, orifice 82 provides a medium rate of flow and orifice 81 provides full or maximum flow rate.

FIG. 7 shows a view of an alternative orifice plate showing three different orifices that provided different flow rates. In this embodiment the orifice plate 80 has an elongated orifice with stepped flow rates. This allows for some limited flow regulation between the finite steps of flow. The low flow 86 has the smallest slit or opening, the medium flow level 85 is shown connected to the full flow rate 84.

FIG. 8 shows a perspective view of a cylindrical gate with different sized orifices that pass through the cylindrical gate. It is also contemplated that this configuration can also be used with a ball type valve. The low 93, medium 92 and full flow orifices 91 are shown passing through the cylindrical body 90. As the body is rotated within the housing, different orifice will be exposed to the inlet and outlet connections. The cylindrical locating base 95 is shown on the bottom of the cylindrical body 90 and the top of the body has a flange for mounting the handle 18 as shown in FIG. 4.

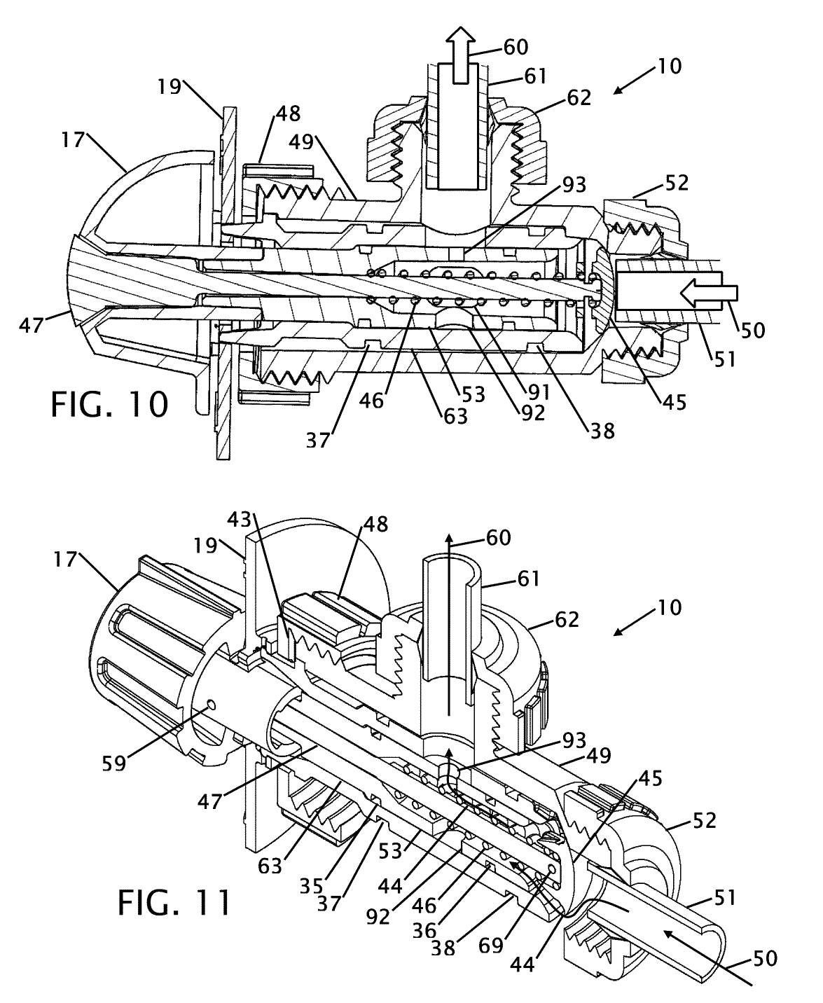

FIG. 9 shows a perspective sectional view of the preferred embodiment of the orifice tube. Water flows into the orifice tube 53 from opening 54. There are three different flow openings 91, 92 and 93 that correspond to full, medium and low flow respectively. The flow rate is determined by the opening that is facing the outlet (60 in FIGS. 10 and 11). On the end that is opposite the inflow 54 there is an elongated shaft or knob shank 34 where the position setting knob is placed. Turning the knob shank 34 allows for setting of the flow rate. The inner tube has a series of annular recesses 35 and 36 for O-rings to be seated to prevent water from flowing outside of the desired area. The inner tube is configured to restrict flow between each plurality of orifices. With this understanding of the preferred embodiment of the inner flow tube 53 the cross sectional views of FIGS. 10 and 11 will show how this inner flow tube 53 operates within the shut off valve 10.

FIG. 10 shows a cross sectional view of the finite flow regulation valve 10. FIG. 11 shows a perspective sectional view of the finite flow regulation valve 10. Water flows 50 into inlet pipe 51. The inlet pipe 51 is secured with an inlet fitting 52 onto the outer housing 49. A gasket or seal prevents leaking of the inlet pipe 51, inlet fitting 52 and the outer housing 49. In the preferred embodiment the outer housing is made from plastic, but other materials such as metals such as aluminum, stainless steel or brass are also contemplated. The water then flows 44 around an end seal 45. The end seal stops flow through the flow regulation valve 10 when there is no demand out of the flow regulation valve 10.

When there is flow out of the outlet 60, the flow will overcome the spring force 46 that holds the end seal 45 closed against the outer housing 49. The flow will then flow 44 past the end seal and into the inner tube 53. O-Ring seats 38 and 36 will prevent flow around the inner tube 53 and the middle tube 63. The flow will then progress around the spring 46 where it will seek and opening, in these figures, 93 where the flow will pass through the middle tube 61 and through the outer housing 49 where the flow will exit through the outlet pipe 61 of the outlet 60. The middle tube 63 has only a single opening that allows flow out of the flow regulation valve 10. O-Ring seats 35 and 37 will prevent flow around the inner tube 53 and the middle tube 63. The outlet pipe 61 is secured with an outlet fitting 62 onto the outer housing 49.

Adjustment of the flow rate is controlled by rotation of the inner tube 53. This inner tube 53 is adjusted with indicator knob 17. An indicator plate 19 has indicium that identifies the flow rate that is selected. The indicator knob 17 is pinned through pinning hole 59 to a central shaft 47 that retains the spring 46 and the end seal 45. The end seal 45 is also pinned with hole 69 to the central shaft 47. An end closure cap 48 closes and secures the control side of the flow regulation valve 10 with a seal 43. From FIG. 10 the low 93, medium 92 and full flow 91 orifices can be seen.

It is further contemplated that the flow regulating orifice can be incorporated into the control valves that are connected to the faucet. This would eliminate the need to replace the shut-off valves and still provide the water savings that are contemplated. Incorporating the regulator into the control valves could be accomplished on every new water faucet being manufactured and result in water conservation.

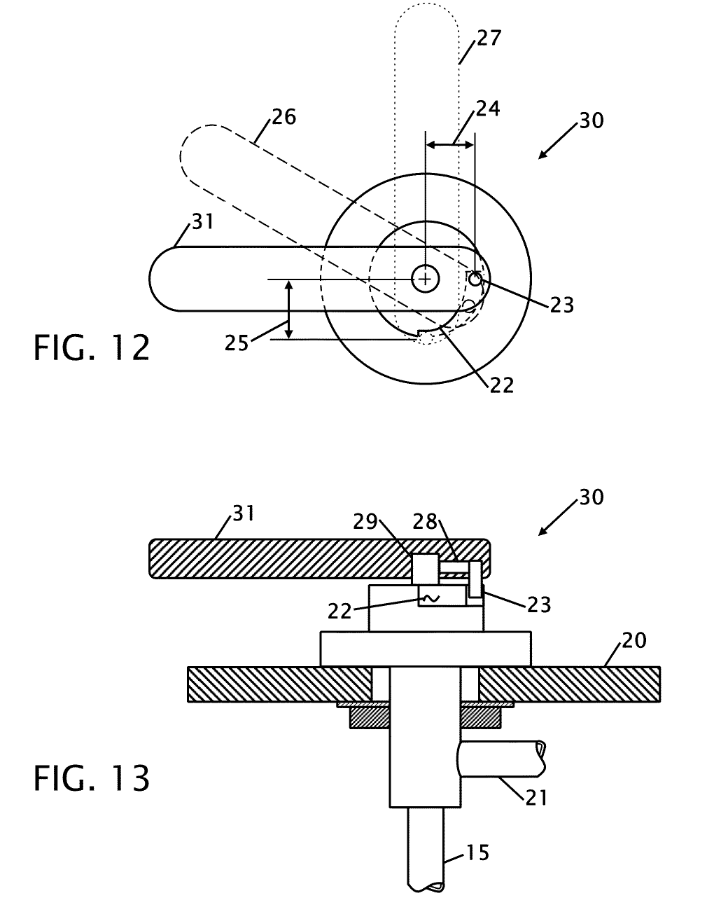

FIG. 12 shows a top view of a flow valve with variable operation force and FIG. 13 shows a side view of the flow valve 30 with variable operation force as shown in FIG. 12. From FIG. 13 the valve 30 has an input flow line 15 and an output flow line 21 mounted on a sink 20 or counter. This is only one contemplated embodiment, but other flow line connections are contemplated. This valve requires a variable amount of force to open the valve 30. The amount of force is variable based upon how far the valve is opened and thereby the amount of flow thought the valve 30. The valve 30 is shown and described as a 90 degree operable valve. When the valve is cracked open or operated with low flow the amount of force to open the valve is minimal. The further the valve is opened tea amount of force increases. This prevents someone from casually fully opening the valve. In the embodiment shown the amount of force linearly increases, but it is also contemplated that the amount of force can be logarithmic or stepped. The force function is set or controlled by a cam 22 and follower 23.

The cam 22 is integrated into the valve housing and it is further contemplated that the cam can be changeable, adjustable or removed, depending upon the installation and the user/installer preference. As the user turns the valve handle 31 the follower 23 is pushed into the cam 22. At the closed position the distance 24 between the valve stem 29 and the follower 23 is at a first distance 24. In the embodiment shown the handle 31 located at position 26 is approximately 30 degrees. At this position the follower 23 just begins to engage into the cam 22. At full open the handle is shown at position 27. In this position the distance 25 between the valve stem 29 and the follower 23 is at a maximum 25 whereby the force to open the valve 30 to this extent is the greatest. The follower 23 is connected to the valve or valve stem 29 with an elastomeric link 28.

While this embodiment shows an elastomeric member 28 that is being used in extension, it is also contemplated that the valve can be designed where the follower is compressed within a cam cavity.

Thus, specific embodiments of a lockable flow control valve have been disclosed. It should be apparent, however, to those skilled in the art that many more modifications besides those described are possible without departing from the inventive concepts herein. The inventive subject matter, therefore, is not to be restricted except in the spirit of the appended claims.

1. A stepped flow control valve comprising:
a housing having an inlet port and an outlet port;
said housing having a valve located between said inlet and outlet valve for regulating a flow between said inlet and outlet port
said valve having a first orifice that provides unlimited flow, at least a second orifice that provides limited flow through said valve.

2. The stepped flow control valve according to claim 1 that further provides an offsetting.

3. The stepped flow control valve according to claim 2 wherein said valve has at two finite flow reductions that are less than full flow.

4. The stepped flow control valve according to claim 2 wherein said valve has at least three finite flow restrictions that are less than full flow.

5. The stepped flow control valve according to claim 1 wherein said housing further has an external securing mechanism that prevents opening said valve beyond second orifice.

6. The stepped flow control valve according to claim 5 that further provides regulation, locking, splattering and replacement of an existing valve.

7. The stepped flow control valve according to claim 1 that is placed between the water control valves and flow head of a shower.

8. The stepped flow control valve according to claim 1 that is placed at the water main of a house, building or residence.

9. The stepped flow control valve according to claim 1 that further includes audible and or tactile detents to identify when said valve is places in each flow limit.

10. The stepped flow control valve according to claim 1 that further has an inner central shaft that is connected to a control indicator knob.

11. The stepped flow control valve according to claim 10 that further includes a spring located around said inner central shaft that is further connected to a seal that prevents flow leaking through said valve when there is no flow appreciable flow through said stepped flow valve.

12. The stepped flow control valve according to claim 11 that further includes an inner tube having a plurality of orifices that provide different finite flow through each orifice.

13. The stepped flow control valve according to claim 12 that further has an indicator plate that identifies each finite flow position of said valve.

14. The stepped flow control valve according to claim 12 wherein said inner tube restricts flow between each plurality of orifices.

15. The stepped flow control valve according to claim 12 wherein said inner tube provides steps of flow between each plurality of orifices.

16. The stepped flow control valve according to claim 11 wherein flow enters a central hole and passes through said inner tube and out of an orifice located on a side of said inner tube.

17. The stepped flow control valve according to claim 16 wherein said inner tube further has at least one annular seal for an O-ring.

18. The stepped flow control valve according to claim 1 wherein said housing is made of plastic.

19. The stepped flow control valve according to claim 1 wherein said housing is made of metal.

20. The stepped flow control valve according to claim 1 wherein a force to open said stepped flow control valve increases as flow rate through said valve increases.
